(19) United States
(12) Patent Application Publication
(10) Pub. No.: US 2020/0282365 A1
(43) Pub. Date: Sep. 10, 2020

(54) Medication-Dispensing Device

(71) Applicants: Keith Katz, Newbury Park, CA (US); Jennifer Katz, Newbury Park, CA (US)

(72) Inventors: Keith Katz, Newbury Park, CA (US); Jennifer Katz, Newbury Park, CA (US)

(21) Appl. No.: 16/571,607

(22) Filed: Sep. 16, 2019

Related U.S. Application Data
(63) Continuation of application No. 15/090,360, filed on Apr. 4, 2016, now abandoned.
(60) Provisional application No. 62/142,801, filed on Apr. 3, 2015.

(51) Int. Cl. B01F 3/20; A61J 7/00; B01F 3/12

(52) U.S. Cl. CPC B01F 3/2071; A61J 3/02; B01F 3/1221; A61J 7/0076

(57) ABSTRACT

Described herein are medication-dispensing devices that can comprise mixing and/or entertainment features. These devises are designed to make the experience of taking medication more tolerable for certain classes of individuals that are averse to taking medication, such as small children. In some embodiments, the devices are interactive and configured such that a user can visualize a medication-mixing process or how his or her interaction effects the device. In some embodiments, the devices can comprise a reward-dispensing portion configured to provide a motivational reward for using the device and thus taking a medication. In some embodiments, the medication-dispensing devices comprise features that emit pleasant or exciting sensory output.

### CROSS REFERENCE TO RELATED APPLICATIONS

This application is a Continuation Application of U.S. patent application Ser. No. 15/090,360, filed Apr. 4, 2016 which claims the benefit of U.S. Provisional Application Patent App. No. 62/142,801, filed on Apr. 3, 2015, the disclosures of which are hereby incorporated by reference in their entireties.

### BACKGROUND

### 1. Field of the Invention

Described herein are devices relating generally to medication-dispensing and mixing, and specifically to dispensing and mixing devices providing encouragement for taking medication, such as entertainment, and/or for mitigating negative experiences involved with taking medication.

### 2. Description of the Related Art

In modern society, many individuals utilize prescription medications. Indeed, as of the writing of the priority provisional application, the US Center of Disease Control and Prevention estimates that the percentage of persons in the United States using at least one prescription drug in the past 30 days is 48.5% (utilizing data from 2007-2010). This includes individuals treating both persistent conditions (such as diabetes and hypertension) and temporary ailments (such as bacterial infections). One certainty is that medication use is prevalent and necessary for the promotion of good health in modern society.

Despite the benefits of medication, some individuals are particularly averse to taking medication. These groups include, for example, individuals with sensitive taste buds, individuals having a phobia of medication and individuals who experience difficulty swallowing. One group in particular that is particularly averse to taking medication is small children. Children often have difficulty swallowing whole pills and require that the medication be grinded up to be presented to them. The resulting powder is often foul tasting. Children also notoriously resist taking even liquid medication due to its bad taste. As children are often easily injured and in contact with other children and various disease-causing agents, the necessity that they take medication for treating various conditions is evident. Much time and energy is wasted by parents trying to get their children to take their medicine.

A device that can provide encouragement for taking medication and/or can mitigate the negative experiences involved with taking medication is therefore needed.

### SUMMARY

Described herein are devices for the dispensing and/or mixing of medication. These devices allow for medication to be mixed with a substance fit for human consumption, such as liquid, food or flavor, and can provide a positive and/or entertaining experience. This “entertainment element” of embodiments incorporating features of the present invention is particularly advantageous for increasing the enjoyability of taking medication for individuals who are particularly adverse to taking medication, for example, individuals with sensitive taste buds, individuals having a phobia of medication, individuals who experience difficulty swallowing and/or small children.

In some embodiments incorporating features of the present invention, medication-dispensing devices include structures for accepting medication, such as solid pills, capsules (or the contents of capsules), or liquid medication, and elements for mixing the medication with a consumable substance, such as a drink, food or flavor, for example, a flavored drink to mask the taste of the medication. Some of these mixing features can include grinding/crushing elements for preparing a solid medication into a more easily dissolved or suspended powdered form and various distribution conduits, such as tubes, that can transport medication and the drink into a common space for mixing.

In some embodiments, medication-dispensing devices according to the present disclosure include various entertainment features designed to increase the enjoyability of the experience of taking medicine. In some embodiments, these entertainment features include interactive features allowing an individual to interact with the device (e.g. by turning a crank, pressing a button, etc.) to effect the device in some manner, such as grinding up the medication or transporting the medication through distribution conduits in the device. In some embodiments, these entertainment features include pleasing sensory emissions, such as pleasing sights, smells and sounds. In some embodiments, the entertainment features include a reward dispenser that dispenses some form of reward (a snack, a prize, etc.) after the medication is dispensed and/or prepared by the device.

In one embodiment, a medication-dispensing device comprises a body, a first medication-accepting portion configured to accept a solid medication, a medication-processing portion in the body connected to the first medication-accepting portion such that a solid medication placed within the first medication-accepting portion can travel from the first medication-accepting portion to the medication-processing portion, the medication-processing portion configured to process the solid medication into a more suitable form for mixing, a consumable-accepting portion configured to accept a liquid, and a common mixing space connected to the first medication-accepting portion and the consumable-accepting portion, such that the medication and the liquid can mix together in the common mixing space.

In another embodiment, a medication-dispensing device comprises a body, a first medication-accepting portion configured to accept a solid medication, a consumable-accepting portion configured to accept a liquid, the consumable-accepting portion separate from the first medication-accepting portion, a common mixing space connected to the first medication-accepting portion and the consumable-accepting portion, such that the solid medication and the liquid can mix together in the common mixing space, and a reward portion integrated into the body, the reward portion configured to dispense a reward.

In yet another embodiment, a medication-dispensing device, comprises an at least partially transparent body, a first medication-accepting portion configured to accept a solid medication, a medication-processing portion in the body, the medication-processing portion connected to the first medication-accepting portion such that a solid medication placed within the first medication-accepting portion can travel from the first medication-accepting portion to the medication-processing portion, the medication-processing portion configured to process the solid medication into a more suitable form for mixing, the medication-processing portion visible through the at least partially transparent body, a consumable-accepting portion configured to accept a liquid, the consumable-accepting portion separate from the first medication-accepting portion, a common mixing space connected to the medication-processing portion and the consumable-accepting portion, such that the solid medication and the liquid can mix together in the common mixing space, and a reward portion integrated into the body, the reward portion configured to dispense a reward, the reward comprising a written message.

These and other further features and advantages of the invention would be apparent to those skilled in the art from the following detailed description, taken together with the accompanying drawings, wherein like numerals designate corresponding parts in the figures, in which:

### BRIEF DESCRIPTION OF THE DRAWINGS

FIG. 1 is a front perspective view of an embodiment of a medication-dispensing device incorporating features of the present invention;

FIG. 2 is a back perspective view of the medication-dispensing device of FIG. 1;

FIG. 3 is a partial exploded view of the medication-dispensing device of FIG. 1;

FIG. 4 is a front perspective view of another embodiment of a medication-dispensing device incorporating features of the present invention;

FIG. 5 is a front perspective view of still another embodiment of a medication-dispensing device incorporating features of the present invention; and

FIG. 6 is a front perspective view of still another embodiment of a medication-dispensing device incorporating features of the present invention.

### DETAILED DESCRIPTION

The present disclosure will now set forth detailed descriptions of various embodiments. These embodiments set forth devices for dispensing and/or mixing medication. In some embodiments, these devices comprise a body, one or more medication-accepting portions and a consumable-accepting portion. The medication-accepting portions can be specifically configured to accept medication in various delivery routes, for example, in pill, powdered and/or liquid form. Devices incorporating features of the present invention can further include processing features that can process medication into a more suitable form for mixing, for example, features for crushing or grinding tablets and distribution conduits to transport medication throughout the device.

Devices incorporating features of the present invention can comprise features for mixing the medication with a consumable substance. Such consumable substances can include any suitable substance fit for human consumption that a medication can be mixed with that does not modify the efficacy of the medication. Preferably the consumable substance makes the medication-taking experience more enjoyable, for example, by making the medication easier to take (such as in cases of integrating a crushed pill into a liquid for individuals who experience difficulty swallowing) or masking a medication's unpleasant flavor with a good-tasting consumable. Examples of such consumable substances include, liquids, such as flavored drinks, foods, especially soft foods, such as gelatin-based foods, puddings and baby food, and various flavored substances, such as viscous substances like syrups and other flavorings.

The mixing features mentioned herein can include various features for transporting the medication to a location in the device where it can be mixed with the consumable substance, for example, in a common space. In some embodiments, the medication has already been sufficiently processed (e.g. grinded, crushed) prior to this transportation, such that mixture with the consumable happens automatically or near-automatically, such as in the case where a pill is grinded into a powder that will now easily dissolve when it comes in contact with a liquid. In some embodiments, further mixing features, such as stirring or tumbling devices, are included to further mix the medication with the consumable substance.

In some embodiments, devices incorporating features of the present invention include “entertainment features,” which include features for providing encouragement for taking medication and/or mitigating the negative experiences involved in taking medication. Some example entertainment features include: sensory output features, interactive features and/or reward features.

Perhaps the most noticeable sensory output of many embodiments of devices incorporating features of the present invention is sight output. The device can comprise visual output features that provide pleasant and/or entertaining visuals during device activation and/or use. For example, the device can produce a visual output in response to the processing features of the device being activated and/or when the medication is finally mixed and dispensed by the device. In some embodiments, the devices include transparent portions allowing a user to visualize the various internal workings for the device, for example, allowing a user to see the medication being processed (e.g. grinded or crushed) and/or see the medication being transported throughout the device. This experience can be interesting and pleasing to some viewers, for example, small children, and may provide motivation for them to take their medication. Additional sight-based sensory outputs the device can comprise include lights, such as incandescent lights or light emitting diodes (LEDs), visual screen displays, holographic displays and/or chemical or bioluminescent displays.

Additional sensory outputs include sound and smell. In some embodiments, the device can emit various smells and/or sounds at certain intervals as described above. This can be entertaining for some users, particularly small children. For example, the device can play music, make arcade-style sounds and/or emit certain scents, such as a bacon scent or lemon scent. Additionally, instead of being scheduled around certain events, such as the dispensing of the medication, the sensory outputs can be randomized. In some embodiments, a control system can be used to determine which events or randomization-schemes are to be implemented to correspond to which sensory output. For example, in some embodiments, a user can select what type of sensory output occurs during a particular phase of device operation, for example, selecting a “rocket ship sound” to occur when the medication travels through a particular distribution conduit.

Devices incorporating features of the present invention can also incorporate various interactive features, for example, features allowing the user to control the device in a certain way. For example, a grinding crank can be implemented that grinds the medication. A dispensing handle can also be implemented that allows a user to control the travel of a mixed medication toward a device dispensing area. When coupled with a transparent visual output, the device can allow a user to interact with the device and directly see the internal device processes being effected as a result of the interaction. For example, a user can turn a grind crank and observe as a tablet is grinded into powder. This can be an entertaining process for certain individuals, for example, small children.

Devices incorporating features of the present invention can further comprise reward features. This is particularly useful in applications of the device designed to encourage small children to take their medicine. After device operation, a reward feature can be configured to dispense a reward to the user. The reward can be dispensed automatically after the device has been operated or can be dispensed in response to a manual activation, such as pressing a button or utilizing a mechanical object, such as a crank, wheel or lever. The reward can be any suitable reward to encourage a user to use the device and thus take his or her medicine. In some embodiments, the reward is a snack, for example, a piece of candy. In some embodiments, the reward is a small toy. In some embodiments, the reward is a sticker or a picture or an inspirational message. In some embodiments, the reward is a “ticket” that a parent can assign a value to in order to allow a child redeem the ticket for a prize. For example, 20 tickets might be a trip to the toy store to pick out a toy, 10 tickets might mean the child gets his or her favorite meal prepared, 100 tickets might be a trip to an amusement park or the zoo.

The various sensory output features, interactive features and/or reward features can be mixed and matched and combined in any number of ways in different embodiments, incorporating features of the present invention. It is not necessary that some or all of the various entertainment features be present. For example, a device can comprise an interactive grinding crank and a transparent portion allowing a user to visualize a pill being grinded up, the powder traveling through a distribution conduit and being mixed with a pleasant-flavored beverage. This same embodiment can comprise a reward portion. Hence, in this example embodiment, a child would be motivated to take their medicine as they get to interact with a machine, their medicine is mixed with a pleasant-tasting beverage and they also get a reward. Various other example embodiments are set forth herein.

Throughout this description, the preferred embodiment and examples illustrated should be considered as exemplars, rather than as limitations on the present invention. As used herein, the term “invention,” “device,” “present invention,” or “present device” refers to any one of the embodiments of the invention described herein, and any equivalents. Furthermore, reference to various feature(s) of the “invention,” “device,” “present invention,” or “present device” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Relative terms, such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein, but are to include deviations in shapes that result, for example, from manufacturing.

It is understood that when a first element is referred to as being “between,” “sandwiched,” or “sandwiched between,” two or more other elements, the first element can be directly between the two or more other elements or intervening elements may also be present between the two or more other elements. For example, if a first element is “between” or “sandwiched between” a second and third element, the first element can be directly between the second and third elements with no intervening elements or the first element can be adjacent to one or more additional elements with the first element and these additional elements all between the second and third elements.

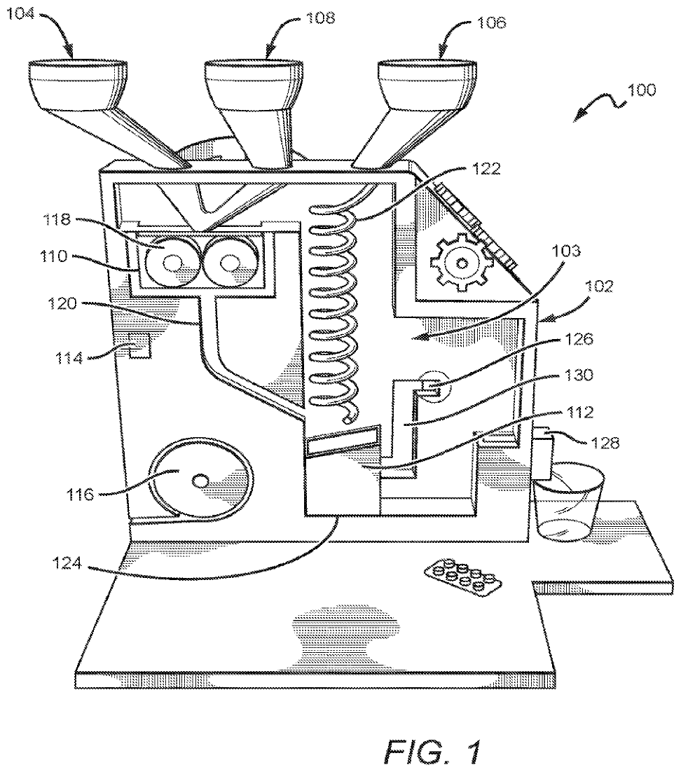

An example embodiment of a medication-dispensing device 100 is shown in FIG. 1. The medication-dispensing device 100 comprises a body 102, and at least one medication-accepting portion 104. In addition to the first medication-accepting portion 104, the medication-dispensing device 100 shown in FIG. 1 further comprises a second medication-accepting portion 106. The first and second medication-accepting portions 104, 106 can be configured, such that one of them is configured to accept a solid or semi-solid medication (such as a pill or tablet), in the illustrated embodiment, this would be the first medication-accepting portion 104, and the other is configured to accept a liquid medication, in the illustrated embodiment, this would be the second medication-accepting portion 106.

The medication-dispensing device 100 can further comprise one or more consumable-accepting portions 108, for accepting a consumable, such as a flavored drink as discussed above. The medication-dispensing device 100 can further comprise one or more processing portions 110 and a medication-collection portion 112, which can be configured to collect the mixture of the medication and the consumable substance. The medication-dispensing device 100 can further comprise various entertainment features, for example a sensory emission portion 114 and/or a reward portion 116.

It is understood that in some embodiments, the consumable-accepting portion 108 is not utilized, but instead one or more of the medication-accepting portions 104, 106 can instead by utilized to accept the consumable substance. Some advantages of having the consumable-accepting portion separate from the medication-accepting portion include ease of cleaning and reduction in the chance of contamination, as well as an improved visual experience in watching the substances be processed in the processing portion 110.

The body 102 can comprise any suitable material that is known to impart structure sufficient to house the various components of the device and which does not negatively affect the efficacy of the medication used with the medication-dispensing device 100. Some example suitable materials that body 102 can comprise, depending on the medication utilized, include, but are not limited to: resin, rubber, vinyl, polyurethane, poly vinyl chloride (PVC), polystyrene foam, polymers/copolymer substances, acrylic substances, plastic, leather, metal, glass, fiberglass, wood, cloth or a combination thereof.

The body 102 can comprise one or more transparent portions 103, which allow a user to see the medication and/or consumable substance during operation of the device 100. These portions can comprise any known transparent material, such as glass or various plastics. In some embodiments, this allows a user to view the medication being processed and/or traveling through various conduits and channels in the device. In some embodiments, this allows a user to see the effect of the user's various interactions with the device.

The medication-accepting portions 104, 106 and the consumable-accepting portion 108 can comprise similar materials to the body 102 and can be made out of the same material or a different material than the body 102. In some embodiments, the various accepting portions 104, 106, 108 are configured based upon their intended use. For example, if the first medication-accepting portion 104 is intended to be used to accept solid medication, it can be shaped, designed or have materials selected for it that facilitate the collection and transport of the solid medication. Likewise, the medication-accepting portions 104, 106 can be configured specifically to accommodate liquid medication and the consumable-accepting portion 108 can be configured based on the type of consumable intended, for example, a liquid drink or pudding.

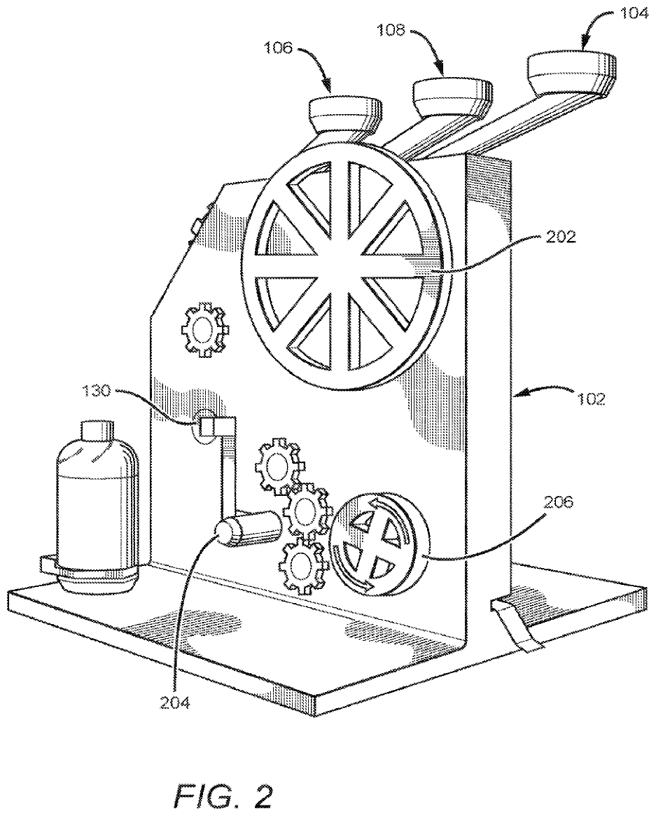

During the operation of the device 100, a medication, for example, a solid medication, is placed into the first medication-accepting portion 104, where it travels through the first medication-accepting portion 104, to the medication-processing portion 110, which is connected to the first medication accepting portion 104. The medication-processing portion 110 can comprise any features known in the art to process medicine, such that it changes into a more convenient state, for example, grinding or crushing mechanisms for transforming solid pills into powder, which can be easily mixed with a liquid, semi-solid, or other substance. In the embodiments shown, the medication-processing portion 110 is a grinding mechanism 118 that can be controlled either through mechanical manipulation, such as by utilizing a crank to move gears or by automation, such as electrically-powered grinders. In the embodiment shown, the grinding mechanism 118 is mechanically and manually operated by a processing control mechanism, which is better shown in FIG. 2.

After the medication has been processed in the medication-processing portion 110, it can travel to the medication-collection portion 112. The medication can be processed either before, after or during introduction of the consumable substance into the consumable-accepting portion 108. One advantage of processing the medication either before or simultaneous with introduction of the consumable substance is that left-over residue from the medication, for example, powdered particles, that is in the medication-processing portion 110 or any distribution conduits, can be effectively rinsed into the medication-collection portion 112.

The medication and/or the consumable substance can be transported through the device via any known transportation structures, such as channels, tubes, pipes and other conduits. In some embodiments, the device 100 comprises one or more distribution conduits 120, 122 (two shown). The first distribution conduit 120 is configured to transport processed medication and/or the consumable substance from the medication-processing portion 110 to the medication-collection portion 112. The distribution conduits can comprise any suitable material known in the art for use in distributing substances, including the same materials the body 102 can comprise. The distribution conduits can comprise the same material as the body or a different material.

The second distribution conduit 122 is configured to collect a substance and deposit it directly into the medication-collection portion 112, bypassing the medication-processing portion. One use of the second distribution conduit 122 can be for liquid medications that do not require processing. In some embodiments, a user can utilize the substance-accepting portion 108 to collect a flavored drink and the second medication-collection portion 106, which is connected to the second distribution conduit 122, to collect a liquid medication. Both the drink and the liquid medication will then be deposited into the medication-collection portion 112, where they can mix together.

The distribution conduits 120, 122 can comprise any number of shapes and orientations, including any regular or irregular polygonal shape, as well as curved and spiral shapes. In some embodiments, the distribution conduits comprise shapes that allow a transported substance to travel in complex and interesting ways, allowing a user to view the travel of the substance.

The medication-collecting portion 112, or common mixing space, is configured to collect the medication and the consumable substance in one location, where the they can mix together. In some embodiments, the medication-collecting portion 112 can comprise a mixing mechanism, for example, a spinning magnet, that can further mix the medication and the consumable substance together. In the embodiment shown, the medication-collecting portion 112 (also referred to as the common mixing space) is moveable between a first position 124, where it is configured to collect medication and consumable substance from the distribution conduits 120, 122, to a second position 126, where is can empty its contents into a medication-distributing portion 128, which dispenses the medication from the device 100 to the user. Alternatively or in addition to utilizing a medication-distributing portion 128, the device 100 can be opened or taken apart to retrieve the medication and it is understood that some embodiments do not utilize a medication-distributing portion.

In the embodiment shown, the medication-collecting portion 112 comprises a medication collection structure, such as a cup, and is moveable along a pre-defined track 130, although it is understood that various known methods of moving an object according to mechanical engineering can be implemented to allow the medication-collection portion 112 to travel from its initial collection position 124 to its secondary position 126, where it can empty its contents into the medication-distributing portion 128.

In some embodiments, the medication-collection portion 112 is not utilized, but instead the medication and/or the consumable substance travels directly from the accepting portions 104, 106, 108 and/or the processing-portion 110 to the medication-distributing portion 128 without first being collected in the medication-collecting portion 112. In these embodiments, the common mixing space for the medication and/or the consumable substance can be common pathways and/or distribution conduits the medication and/or the consumable substance travels through in route to the medication-distribution portion 128. At least one advantage of utilizing the medication-collecting portion 112 is that it allows another interaction of the user to interact with and thus gain enjoyment from the device 100. In the embodiment shown, the medication-collecting portion 112 is configured to travel along the track 130 in conjunction with a collection transport control mechanism, which is better shown in FIG. 2.

The device 100 can further comprise a sensory emission portion 114, which is shown schematically. This sensory emission portion 114 can include various light, image, sound and scent emitting features, which are known. In some embodiments, the sensory emission portion 114 includes fragrance emitters, LEDs, display screens and/or audio structures. In some embodiments, the sensory emission portion 114 can be coupled with a printed circuit board (PCB) with a control circuit or other electronics.

The device 100 can further comprise a reward portion 116 integrated into or otherwise connected to the body 102, configured to dispense a reward, as described herein. In the embodiments shown, the reward portion 116 is a manually operated paper dispenser that can dispense paper rewards, such as “tickets,” stickers or messages. It is understood that while these rewards are referred to as “paper rewards” it is understood that printed messages, for example, on tickets, can be printed on other materials capable of having messages printed on them. In other embodiments, as is discussed above, the reward portion 116 can dispense snacks or toys. In some embodiments, the reward portion 116 is mechanical. In other embodiments, the reward portion 116 is automated and/or comprises electronic components. In the embodiment shown, the reward portion 116 is controlled by a reward dispensing control mechanism, which is better shown in FIG. 2.

FIG. 2 shows a back view of the medication-dispensing device 100, which better shows some of the control mechanisms that help control the various features of the device 100. FIG. 2 shows the body 102, first medication-accepting portion mechanism 104, the second medication-accepting portion 106 and the substance-accepting portion 108.

FIG. 2 also shows a processing control mechanism 202, which is coupled to the grinding mechanism 118 in FIG. 1, such that activation of the processing control mechanism 202 causes the grinding mechanism 118 to function and process medication deposited in the device. In the embodiment shown, the processing control mechanism 202 comprises a wheel operably connected to the grinding mechanism 118, such that turning the wheel causes the grinding mechanism to operate. It is understood, however, that other control mechanisms can be used, including automated and electrical mechanisms, as well as other various known mechanical mechanisms.

FIG. 2 further shows the collection transport control mechanism 204, which is operably coupled to the medication-collection portion 112 shown in FIG. 1, such that movement of the collection transport control mechanism 204, along the track 130 causes corresponding movement of the medication-collection portion 112. FIG. also further shows a reward dispensing control mechanism 206, which is operably coupled to the reward portion 116 shown in FIG. 1, such that movement of the reward dispensing control mechanism 206 causes the reward portion 116 to dispense a reward. While the embodiments shown in FIG. 2 shows particular manual mechanisms for the collection transport control mechanism 204 and the reward dispensing control mechanism 206, like with the processing operation control mechanism 202, it is understood that other control mechanisms can be used, including automated and electrical mechanisms, as well as other various known mechanical mechanisms.

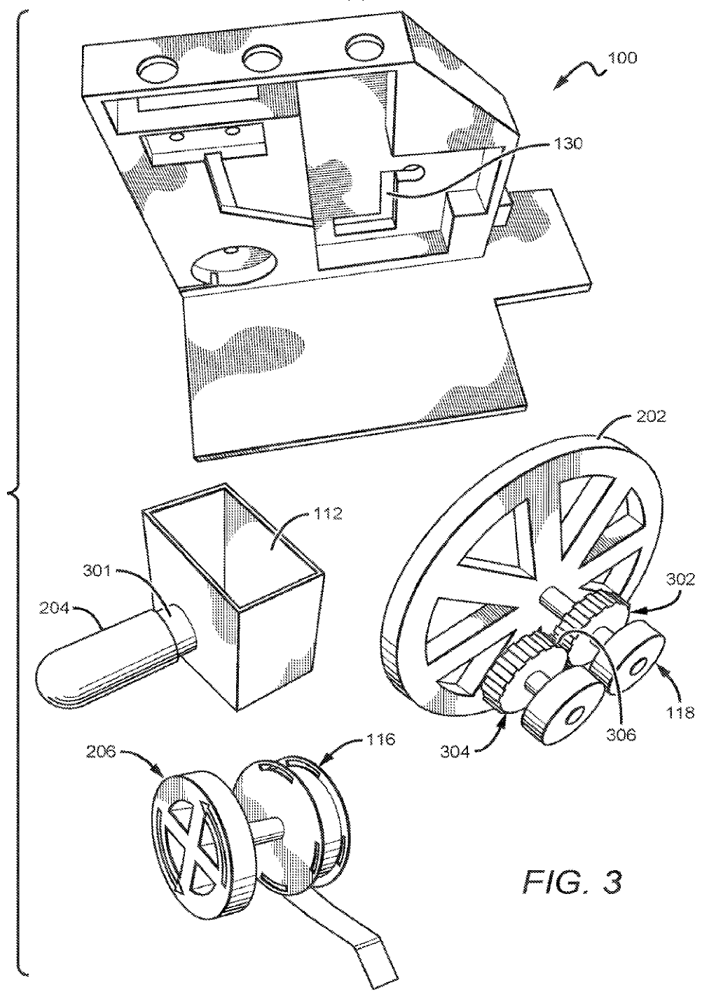

FIG. 3 shows a partial exploded view of the medication-dispensing device 100, which shows some more detail regarding some of the various components of the device 100. FIG. 3 shows that the processing control mechanism 202 is connected to the grinding mechanism 118, such that a first gear 302 rotates with the processing control mechanism 202 and grinds against a second gear 304, producing a grinding effect at a point 306 where a medication can be grinded. FIG. 3 further shows that collection transport control mechanism 204 is connected to medication-collection portion 112 via interconnect portion 308, which is configured to travel along the track 130, such that movement of the collection transport control mechanism 204 causes like movement of the medication-collection portion 112 along the track 130. FIG. 3 further shows reward dispensing control mechanism 206 being connected to the reward portion 116 such that movement of the reward dispensing control mechanism 206 causes like movement of the reward portion 116 and thus dispensing of the reward.

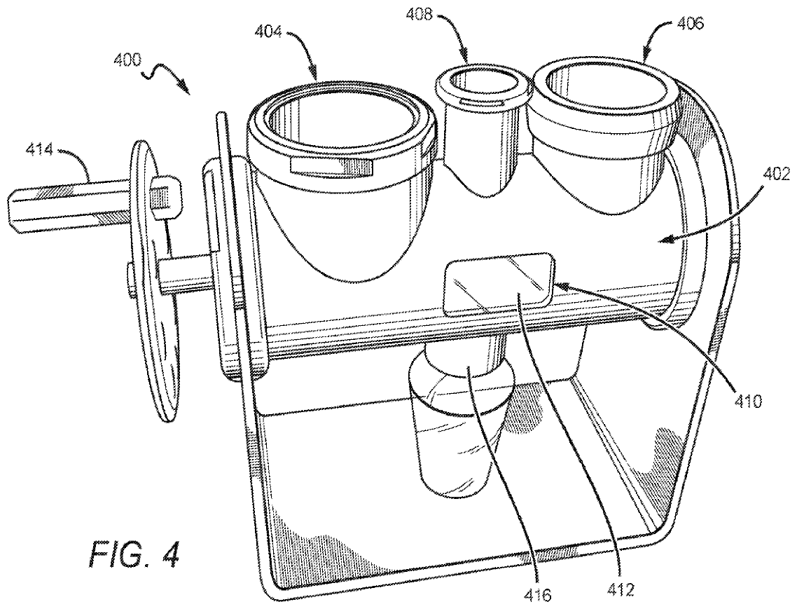

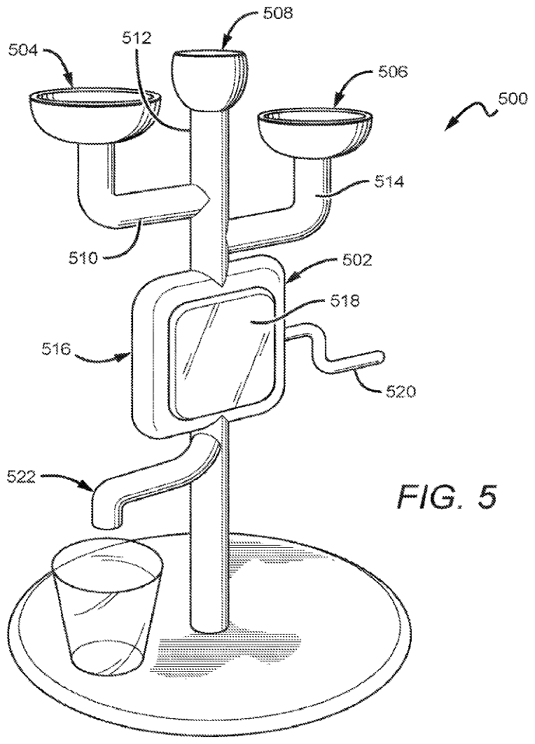

FIGS. 4-5 show some example alternative embodiments of medication-dispensing devices incorporating features of the present invention. FIG. 4 shows a medication-dispensing device 400, comprising a body 402, a first medication-accepting portion 404 a second medication-accepting portion 406 and a substance-accepting portion 408. The various accepting portions 404, 406, 408 can comprise channels and/or distribution conduits as disclosed above and deposit the medication and/or consumable substances in a processing portion 410, which has a transparent viewing window 412, which can allow a user to view the medication processing as it happens. The processing portion 410 can comprise processing elements, such as medication crushers/grinders that can be controlled by a processing control mechanism 414. After the medication has been processed, it can then travel to distributing portion 416 which is connected to the processing portion 410 or other common mixing space, and which is configured to dispense the medication from the device 400 to the user.

FIG. 5 shows a medication-dispensing device 500, comprising a body 502 a first medication-accepting portion 504 a second medication-accepting portion 506 and a substance-accepting portion 508. Unlike in the other FIGS above, the various accepting portions 504, 506, 508 comprise first 510, second 512, and third 514 pipes which can transport the medication and consumable substances to a processing portion 516, which has a transparent viewing window 518, which can allow a user to view the medication processing as it happens. The processing portion 516 can comprise processing elements, such as medication crushers/grinders that can be controlled by a processing control mechanism 520. After the medication has been processed, it can then travel to distributing portion 522, which dispenses the medication from the device 500 to the user.

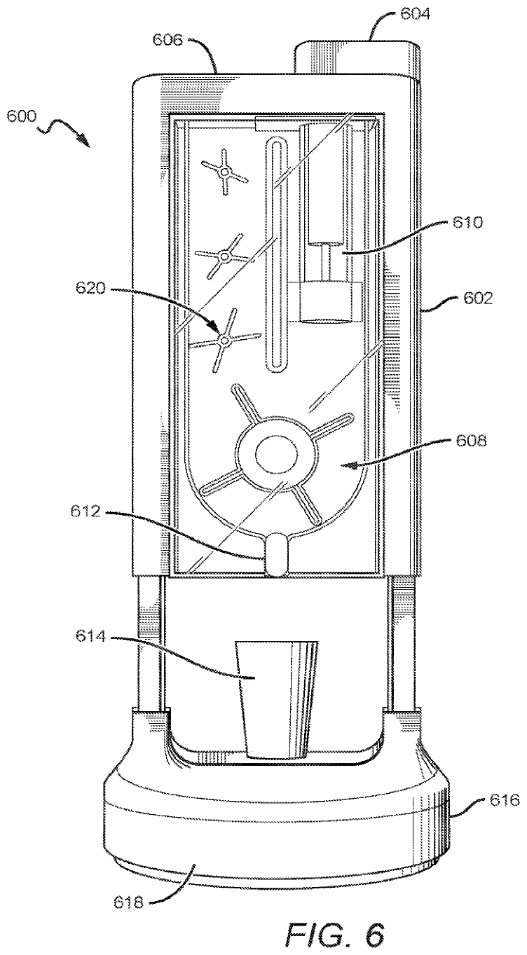

FIG. 6 shows another embodiment of a medication-dispensing device 600 incorporating features of the present invention, comprising a body 602 a first medication-accepting portion 604 and a consumable-accepting portion 606. In the embodiment shown, the first medication-accepting portion 604 is configured to accept a solid medication, such as a pill or tablet and the consumable-accepting portion 606 is configured to accept a liquid or food, such as a flavored drink or pudding as discussed herein. In the embodiment shown, the first medication-accepting portion 604 and the consumable-accepting portion 606 are separate from one another and are connected to a common mixing space 608 such that liquid placed into the consumable-accepting portion 606, and solid medication placed into the first medication-accepting portion 604, can travel to the common mixing space 608.

In the embodiment shown in FIG. 6, the first medication-accepting portion 604 is connected to medication-processing portion 610, which is configured to process a solid medication into a more suitable physical form for mixing, for example, by crushing or grinding the medication, for example, through automated operation or manually operated mechanism. The first medication-accepting portion 604 is connected to the medication-processing portion 610, which is in turn connected to the common mixing space 608. Unlike the embodiment in FIG. 1, the medication-processing portion 610 is not a common mixing space, as the consumable-accepting portion 606 is configured to bypass the medication-processing portion 610 and transport the liquid directly to the common mixing space 608.

In the embodiment shown, the medication-dispensing device 600 can also comprise a distributing portion 612 connected to the common mixing space 610 and configured to dispense medication from the device 600, for example, into a collection cup 614. In the embodiment shown, the distributing portion 612 comprises a pull-out lever or stopper that allows distribution in a first position and restricts distribution in a second position, although it is understood that any known distribution mechanism can be utilized. It is understood that in some embodiments, a distributing portion 612 is not utilized as mentioned above.

The medication-dispensing device 600 in FIG. 6 can further comprise a reward portion 616, configured to dispense a reward. In the embodiment shown, the reward portion 616 comprises a ticket dispenser that is configured to print tickets with printed messages on them. In the embodiment shown, the device 600 further comprises a timer 618. The timer can be configured to operate the device at certain times (e.g. be timed to a certain time of day, time zone or internet time) and/or to dispense a reward after elapse of a countdown (e.g. as in a stopwatch or sand-based timer). In some embodiments, the timer 618 simply acts as a standard timer and a user can perform an action, for example, manually remove a ticket, in response to the timer 618. In some embodiments, the timer 618 can be operated by turning the timer to a preset location corresponding to a time which it will count down from, for example, similar to an egg timer.

The medication-dispensing device 600 in FIG. 6 can further comprises interactive components 620, which are configured to move in response to liquid traveling from said consumable-accepting portion 606 to the common mixing space 608 and/or solid medication travelling from said first-medication accepting portion 604 and/or the medication-processing portion 610 to the common mixing space. At least one advantage of the interactive components 620 is that they allow for further appealing visual experiences as one watches the medication travel through the device 600 and can further mix or process the medication. In the embodiment shown, the interactive components 620 comprise wheel-like features configured to rotate about a central axis, however, it is understood that other interactive component 620 configurations that move in response to traveling solid medication or liquid can be utilized.

It is understood that while the disclosed embodiments have both mixing and entertainment features, both features are not needed and devices incorporating features of the present invention can include devices with only mixing features or only entertainment features. For example, a device that stores and/or dispenses medication for a child that comprises entertainment features that encourage a child to take his or her medication or become excited when it is time to take medication would be within the scope of the present disclosure whether or not the device mixed the medication with a consumable substance. Likewise, a mixing device that mixed a medication with a consumable substance to improve the flavor of the medication would be within the scope of the present disclosure whether or not the device comprised entertainment features.

In some embodiments incorporating features of the present invention, various features involved in the transportation and/or distribution of medication and/or the consumable substance can comprise features that prevent excess portions of the transported substances from becoming stuck or not completing the transportation. For example, the various medication- and substance-accepting portions and distribution conducts can comprise a material that a liquid or viscous substance will not stick to and/or can be treated with a material that prevents or mitigates sticking, including, but not limited to, hydrophobic substance or a material that provides a perpetually wet liquid-impregnated surface.

In some embodiments, the devices can comprise various measuring and dosage features for determining a medication's correct dosage. For example, a medication-accepting portion that is configured to receive a liquid can comprise hash marks denoting volumetric measurements such as milliliters allowing a user to pour out a correct dosage of medication into the medication-accepting portion. Particularly in these embodiments, but also in other embodiments not incorporating one or more measuring feature, features that will stop the medication from traveling further into the device (such as into the processing-portion or the medication-collection portion) until the measuring is completed can be incorporated. Any suitable known stopping feature can be used for this purpose, including various valves and flow-back prevention mechanisms known in the art of fluid dynamics. In some embodiments, various sensors, for example, electronic sensors, can be used for measurement purposes. Such sensors can include, but are not limited to, volume, weight and chemical concentration sensors.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

What is claimed:

1. A medication-dispensing device, comprising:
a body;
a first medication-accepting portion configured to accept a solid medication;
a medication-processing portion in said body, said medication-processing portion connected to said first medication-accepting portion such that a solid medication placed within said first medication-accepting portion can travel from said first medication-accepting portion to said medication-processing portion, said medication-processing portion configured to process said solid medication into a more suitable form for mixing;
a consumable-accepting portion configured to accept a liquid; and
a common mixing space connected to said first medication-accepting portion and said consumable-accepting portion, such that said solid medication and said liquid can mix together in said common mixing space.

2. The medication-dispensing device of claim 1, wherein said medication-processing portion is said common mixing space.

3. The medication-dispensing device of claim 1, wherein said medication-processing portion is separated from and connected to said common mixing space.

4. The medication-dispensing device of claim 1, further comprising a distributing portion, said distributing portion connected to said common mixing space and configured to dispense medication from said device.

5. The medication-dispensing device of claim 1, wherein said medication-processing portion is configured to grind or crush said solid medication.

6. The medication-dispensing device of claim 1, wherein at least a portion of said body is transparent.

7. The medication-dispensing device of claim 6, wherein said common mixing space is visible through said transparent body portion.

8. The medication-dispensing device of claim 6, wherein said medication-processing portion is visible through said transparent body portion.

9. The medication-dispensing device of claim 1, further comprising interactive components, said interactive components configured to move in response to said liquid traveling from said consumable-accepting portion to said common mixing space.

10. The medication-dispensing device of claim 1, further comprising a sensory emission portion configured to emit sensory output in the form of light, images, sound or scent.

11. A medication-dispensing device, comprising:
a body;
a first medication-accepting portion configured to accept a solid medication;
a consumable-accepting portion configured to accept a liquid, said consumable accepting portion separate from said first medication-accepting portion;
a plurality of interactive components configured to move in response to said solid medication traveling from said first medication-accepting portion to a common mixing space and/or said liquid traveling from said consumable-accepting portion to the common mixing space, the common mixing space connected to said first medication-accepting portion and said consumable-accepting portion, such that said solid medication and said liquid can mix together in said common mixing space; and
a reward portion integrated into said body, said reward portion configured to dispense a reward.

12. The medication-dispensing device of claim 11, wherein said reward comprises paper.

13. The medication-dispensing device of claim 11, wherein said reward comprises a printed message.

14. The medication-dispensing device of claim 11, wherein said reward portion is configured to dispense said reward in response to a timer.

15. The medication-dispensing device of claim 11, wherein said reward portion is configured to dispense a reward in response to user input.

16. The medication-dispensing device of claim 11, wherein said reward portion is configured to dispense a reward in response to manual activation.

17. The medication-dispensing device of claim 11, wherein at least a portion of said body is transparent.

18. The medication-dispensing device of claim 17, wherein said common mixing space is visible through said transparent body portion.

19. The medication-dispensing device of claim 11, wherein said common mixing space comprises a medication collection structure that is moveable in response to user interaction.

20. A medication-dispensing device, comprising: An at least partially transparent body; a first medication-accepting portion configured to accept a solid medication; a medication-processing portion in said body, said medication-processing portion connected to said first medication-accepting portion such that a solid medication placed within said first medication-accepting portion can travel from said first medication-accepting portion to said medication-processing portion, said medication-processing portion configured to process said solid medication into a more suitable form for mixing, said medication-processing portion visible through said at least partially transparent body; a consumable-accepting portion configured to accept a liquid, said consumable accepting portion separate from said first medication-accepting portion; a common mixing space connected to said medication-processing portion and said consumable-accepting portion, such that said solid medication and said liquid can mix together in said common mixing space; and a reward portion integrated into said body, said reward portion configured to dispense a reward, said reward comprising a written message.
